(19) United States
(12) Patent Application Publication
(10) Pub. No.: US 2014/0025942 A1
(43) Pub. Date: Jan. 23, 2014

(54) INFORMATION PROCESSING APPARATUS, INFORMATION PROCESSING METHOD, AND PROGRAM

(71) Applicant: Shinzi Nakazima, Nagano (JP)

(72) Inventor: Shinzi Nakazima, Nagano (JP)

(73) Assignee: SONY CORPORATION, Tokyo (JP)

(21) Appl. No.: 14/007,339

(22) PCT Filed: Mar. 22, 2012
(86) PCT No.: PCT/JP2012/001988

§ 371 Date: Sep. 25, 2013

(30) Foreign Application Priority Data
Apr. 6, 2011 (JP) 2011-084207

(51) Int. Cl. G06F 9/44

(52) U.S. Cl. CPC G06F 9/4408
USPC 713/2; 713/1

(57) ABSTRACT

An information processing apparatus, method and computer program product offer alternative ways to power-up an information processing device. Depending on which of multiple triggering devices are actuated, the information processing device performs either a fast power-up sequence or a more lengthy, but more complete power-up sequence.

### TECHNICAL FIELD

The present disclosure relates to an information processing apparatus such as a personal computer (PC) including a removable drive, an information processing method in the information processing apparatus, and a computer program storage medium.

### BACKGROUND ART

From the past, when an information processing apparatus such as a PC is powered on, a basic input/output system (BIOS) recognizes a removable medium such as an optical medium or a universal serial bus (USB) memory before booting an operating system (OS) stored in a built-in medium such as a hard disk drive (HDD). Further, a user can boot an OS from the removable medium, set the BIOS, and so on by pressing, for example, a function key within several seconds after power-on.

Thus, in a traditional PC, recognition of a removable medium is constantly executed, and hence some waiting time for the user occurs after power-on before booting from a built-in medium is completed.

Japanese Patent Application Laid-open No. 2006-344059 discloses an information processing apparatus in which out of initial boot programs, programs for realizing particular functions are stored in a flash memory and the other programs are stored in an HDD. Such an information processing apparatus concurrently executes booting from the flash memory and booting from the HDD, which allows the user to know that all of initial booting are completed at the time when the booting from the flash memory is completed.

### CITATION LIST

### Patent Literature

PTL 1: Japanese Patent Application Laid-open No. 2006-344059

### SUMMARY

However, in the technique disclosed in Japanese Patent Application Laid-open No. 2006-344059, even if the initial booting is appeared to the user as being completed, booting for the programs stored in the HDD is not completed in effect. Consequently, if the user wants to execute those programs, he or she has to wait for completion of all of booting.

In view of the above-mentioned circumstances, there is a need for providing an information processing apparatus, an information processing method, and a program, that are capable of fast booting an OS from a built-in medium according to a user's purpose of use.

According to an information processing device embodiment, the device includes

a processing circuit that

performs a first power-on sequence from a first medium when a first triggering device is detected as being actuated, and

performs a second power-on sequence when a second triggering device is detected as being actuated, wherein

the first power-on sequence includes recognition of a removable medium and the second power-on sequence excludes recognition of a second medium.

According to one aspect,

the second medium is a removable medium that includes one of an optical medium and a universal serial bus memory.

According to another aspect

the first power-on sequence is a boot sequence, and the second power-on sequence being completed in a shorter amount of time than the first power-on sequence.

According to another aspect

the boot sequence recognizes and initializes the removable medium, and generates a menu screen that is displayed on a display.

According to another aspect, the device further includes

the first triggering device and the second triggering device, the first triggering device being a different device than the second triggering device.

According to another aspect

the first triggering device and the second triggering device are user-actuatable.

According to another aspect

at least one of the first triggering device and the second triggering device is triggered in response to a received signal transmitted from a remote device.

According to another aspect

in response to the second triggering device being actuated after the first power-on sequence has started, the processing circuit provides display of a user-selectable control option of booting from a power-on sequence stored on the removable medium.

According to another aspect

in response to the second triggering device being actuated after the first power-on sequence has started, the processing circuit provides a plurality of user-selectable control options of booting from different power-on sequences stored on different removable media.

According to another aspect

the second power-on sequence is performed using computer readable instructions stored in a medium accessed via a network.

According to another aspect

the second power-on sequence includes recovery processing that provides a reboot capability after a system crash.

According to another aspect

the second power-on sequence includes display of a BIOS setting screen.

According to another aspect

the second power-on sequence includes executing a boot sequence of an operating system stored in a local storage device.

According to another aspect

said received signal is a wireless signal.

According to an information processing method embodiment, the method includes

performing a first power-on sequence with a processing circuit from a first medium when a first triggering device is detected as being actuated; and

performing a second power-on sequence when a second triggering device is detected as being actuated, wherein

the first power-on sequence includes recognizing a removable medium and the second power-on sequence excludes recognizing of a second medium.

According to one aspect of the method embodiment

receiving a signal transmitted from a remote device, wherein

at least one of the first triggering device and the second triggering device is triggered in response to receiving the signal.

According to another aspect of the method, the method further includes

recognizing an actuation of the second triggering device after the first power-on sequence has started, and displaying of a user-selectable control option of booting from a power-on sequence stored on the removable medium.

According to another aspect of the method, the method further includes

recognizing the second triggering device as being actuated after the first power-on sequence has started, and in response displaying a plurality of user-selectable control options of booting from different power-on sequences stored on different removable media.

According to a non-transitory computer readable storage medium embodiment, the medium has computer readable instructions stored therein that when executed by a processing circuit perform a method that includes

performing a first power-on sequence with the processing circuit from a first medium when a first triggering device is detected as being actuated; and

performing a second power-on sequence when a second triggering device is detected as being actuated, wherein the first power-on sequence includes recognizing a removable medium and the second power-on sequence excludes recognizing of a second medium.

According to one aspect of the medium, the method further includes

receiving a signal transmitted from a remote device, wherein

at least one of the first triggering device and the second triggering device is triggered in response to receiving the signal.

As mentioned above, according to the present disclosure, it is possible to fast boot an OS from a built-in medium according to a user's purpose of use.

### BRIEF DESCRIPTION OF DRAWINGS

FIG. 1 is a diagram showing a hardware configuration of a personal computer (PC) according to an embodiment of the present disclosure.

FIG. 2 is a flow chart showing a flow of operations when an assist button is pressed in the PC.

FIG. 3 is a diagram showing an example of a menu screen displayed in the PC.

FIG. 4 is a diagram showing another example of the menu screen displayed in the PC.

FIG. 5 is a flow chart showing a flow of operations when a power button is pressed in the PC.

FIG. 6 is a flow chart showing a flow of operations when an assist button is pressed after booting an operating system (OS) in the PC.

### DESCRIPTION OF EMBODIMENTS

Hereinafter, an embodiment of the present disclosure will be described with reference to the drawings.

(Hardware Configuration of Personal Computer (PC))

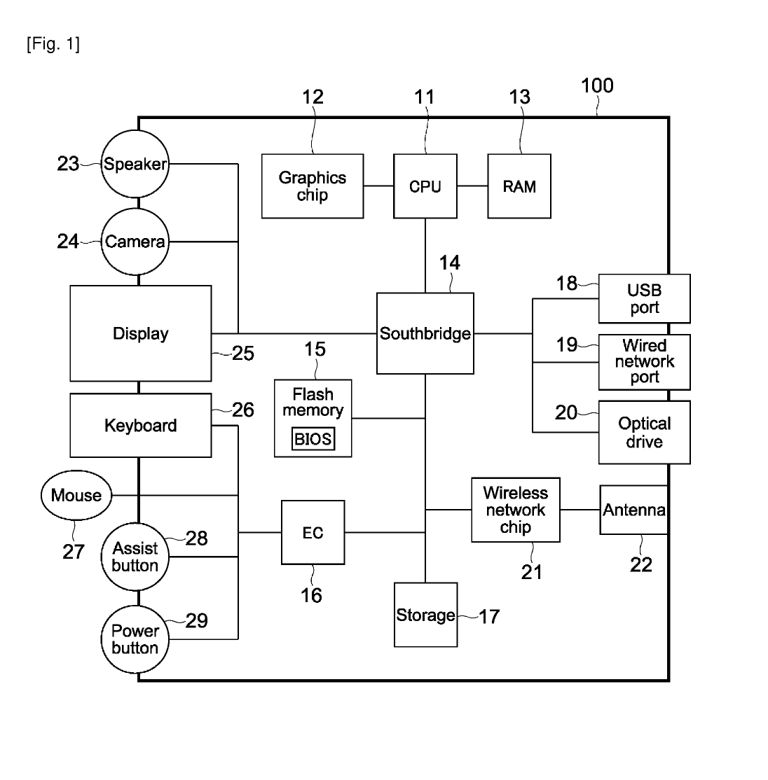

FIG. 1 is a diagram showing a hardware configuration of a PC according to this embodiment.

A PC 100 is, for example, a laptop PC, but the PC 100 may be a desktop PC or a tablet PC. As shown in the figure, the PC 100 includes a central processing unit (CPU) 11, a graphics chip 12, a random access memory (RAM) 13, a southbridge 14, a flash memory 15, an embedded controller (EC) 16, and a storage 17.

The PC 100 further includes a universal serial bus (USB) port 18, a wired network port 19, an optical drive 20, a wireless network chip 21, an antenna 22, a speaker 23, a camera 24, a display 25, a keyboard 26, and a mouse 27. In addition, the PC 100 includes an assist button 28 and a power button 29.

The CPU 11 appropriately accesses the RAM 13 or the like depending on needs and performs overall control of entire blocks of the PC 100 while executing various types of arithmetic processing. The graphics chip 12 executes, in cooperation with the CPU 11 or in place of the CPU 11, various types of image processing. The RAM 13 is used as a working area or the like for the CPU 11 and temporarily stores an operating system (OS), various running applications, and various types of data being processed.

The southbridge 14 is one of chips forming a core of the PC 100, that performs, together with the CPU 11, control or the like on the USB port 18, the optical drive 20, and the like. The flash memory 15 is a non-volatile memory in which a basic input/output system (BIOS) is stored. The BIOS is a program for a boot of the PC 100 and a control on hardware of the optical drive 20, the keyboard 26, the graphics chip 12, and the like. The BIOS serves to initialize various types of hardware so as to mediate control of an OS such as Windows (Registered Trademark) for control.

The EC 16 is a chip that performs control on input devices such as the keyboard 26 and the mouse 27 and power-supply control. The EC may be implemented as a program.

The storage 17 is, for example, a non-volatile memory such as a hard disk drive (HDD), a flash memory as a solid state drive (SSD), other solid-state memories and functions as a built-in storage medium for the PC 100. In the storage 17, an OS, various applications, various types of utility software, and various types of data are stored. In particular, in this embodiment, in the storage 17, there are also stored an application (referred to as rescue application) for executing rescue processing as will be described later, image data necessary for displaying a graphical user interface (GUI) for the rescue application, and the like.

The USB port 18 connects to a USB memory as a removable medium, a removable medium drive connected to a USB cable, and the like and communicates with those devices based on a USB standard.

The wired network port 19 is, for example, an Ethernet (Registered Trademark) port. The wired network port 19 connects to a network via a cable and communicates with a device on the network. For example, the wired network port 19 is also capable of downloading an OS from the device on the network and the BIOS is also capable of using the downloaded OS to boot the PC 100 instead of the OS stored in the storage 17.

The optical drive 20 loads, for example, an optical disk as a removable medium, such as a Blu-ray disc (BD), a digital versatile disc (DVD), or a compact disc (CD) and reads data stored in the optical disk and writes data on the optical disk. The BIOS is also capable of using the OS stored in the removable medium mounted in the optical drive 20 to boot the PC 100 instead of the OS stored in the storage 17.

The wireless network chip 21 communicates with the device on the network via the antenna 22 based on a wireless standard such as a wireless local area network (WLAN), a wireless wide area network (WWAN), a worldwide interoperability for microwave access (WIMAX), BLUETOOTH (Registered Trademark), or TransferJet (Registered Trademark), for example. The BIOS is also capable of using the OS downloaded by the wireless network chip 21 to boot the PC 100 instead of the OS stored in the storage 17.

The speaker 23 outputs an audio signal generated by the CPU 11. The camera 24 uses, for example, an image pick-up element such as a complementary metal oxide semiconductor (CMOS) sensor or a charge coupled device (CCD) sensor, to pick up a still image (photograph) and a moving image.

The display 25 is, for example, a liquid crystal display (LCD), an organic electroluminescent display (OELD), or a display device using a cathode ray tube (CRT) or the like and outputs a video signal drawn by the graphics chip 12. For example, the display 25 displays the GUI (menu screen) for the rescue application that will be described later.

The keyboard 26 and the mouse 27 receive various operation inputs made by the user. Instead of the keyboard 26 and the mouse 27, operation inputs may be made through a touch panel provided integrally with the display 25.

The power button 29 supplies, when pressed by the user, power to respective sections of the PC 100 via a battery and an alternating current (AC) adapter (not shown). Further, the power button 29 becomes a trigger for booting the OS stored in the storage 17.

The assist button 28 supplies, when pressed by the user, power to the respective sections of the PC 100. Further, the assist button 28 becomes a trigger for booting the rescue application. Here, the rescue application is an application for displaying information for maintaining the PC 100, dealing with troubles, etc. as the menu screen and executing various types of setting, booting, recovery processing, and the like depending on a user's selection.

In the case where the PC 100 is a laptop PC, the power button 29 and the assist button 28 are provided in a top portion on a surface of a case in which the keyboard 26 is provided, for example. As a matter of course, the power button 29 and the assist button 28 may be provided not as buttons but, for example, mechanical switches such as slide switches.

(Operation of PC)

Next, operations of the PC 100 configured as described above, mainly operations when the assist button 28 or the power button 29 is pressed, will be described.

(Operation when Assist Button is Pressed)

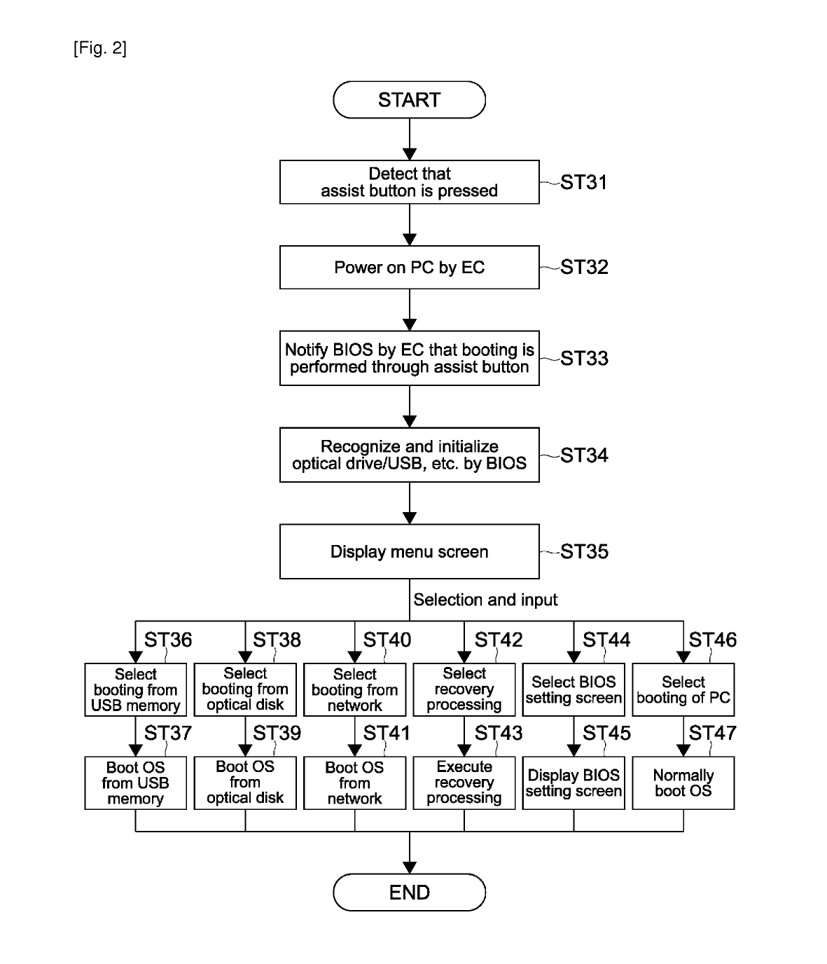

FIG. 2 is a flow chart showing a flow of operations of the PC 100 when the assist button 28 is pressed.

As shown in the figure, first, the EC 16 detects that the assist button 28 is pressed in a state in which the PC 100 is powered off (Step 31) and then, powers on the PC 100 (Step 32).

Subsequently, the EC 16 notifies the BIOS that a boot operation of the PC 100 is performed through the assist button 28 (Step 33).

Subsequently, the BIOS recognizes the removable medium such as the optical disk mounted in the optical drive 20 or the USB memory connected to the USB port 18 and initializes the drive such as the optical drive 20 or the USB port 18 (Step 35).

Subsequently, the BIOS displays the menu screen (Step 35).

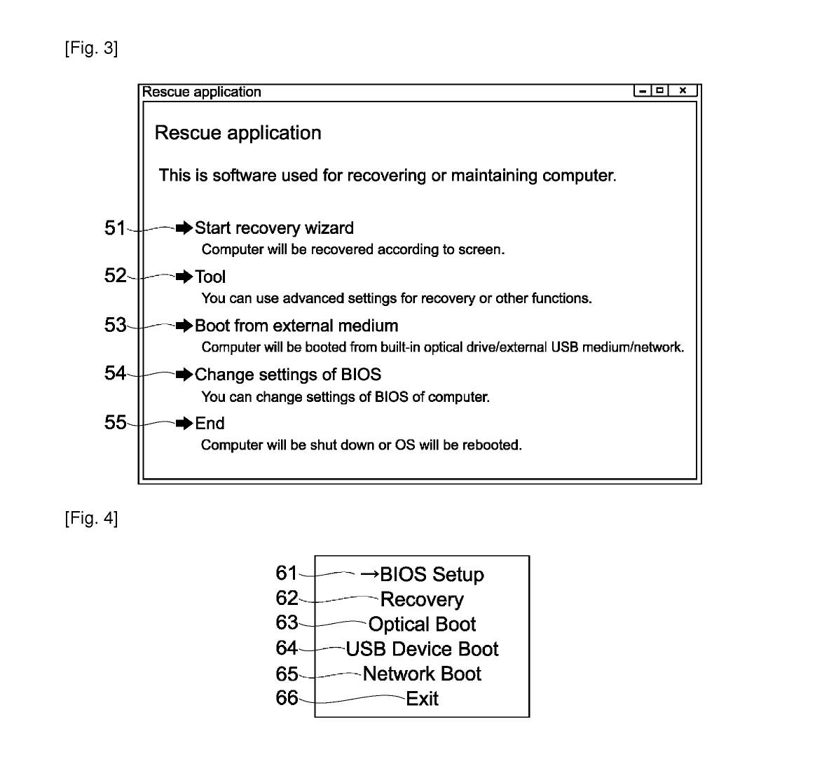

FIGS. 3 and 4 show diagrams showing examples of the menu screen. Out of them, FIG. 3 shows an example of the menu screen displayed by the rescue application as a GUI and FIG. 4 shows an example of the menu screen directly displayed by the BIOS.

After recognizing the removable medium and initializing the drive, the BIOS boots a utility OS (for example, Windows (Registered Trademark) PE) that is different from the OS stored in the storage 17 and has limited functions, and uses the utility OS to boot the rescue application. Then, in the case where image data to be used in the GUI for the rescue application is present in the storage 17, the BIOS displays the menu screen as the GUI as shown in FIG. 3. Otherwise, in the case where it is not present therein, for example, in the case where the image data is deleted by the user, the BIOS directly displays the menu screen as shown in FIG. 4.

As shown in FIG. 3, on the menu screen displayed by the rescue application, there are displayed an option 51 for starting a wizard for recovering the PC 100 (initialization of data in the HDD, creation of a recovery disk, etc.), an option 52 for performing advanced settings for recovery and the like, an option 53 for booting the PC 100 (OS) from an external medium, an option 54 for changing settings of the BIOS, and an option 55 for shutting down the PC 100 or rebooting the OS stored in the storage 17.

The external media in the option 53 are, for example, the optical disk mounted in the optical drive 20, the USB device (medium) connected to the USB port 18, and the device on the network, which is connected to the wired network port 19 or the wireless network chip 21. Further, in the case where the option 53 is selected, a screen for selecting any of the external media is further displayed.

As shown in FIG. 4, on the menu screen displayed by the BIOS, there are displayed an option 61 for changing the settings of the BIOS, an option 62 for recovering the PC 100, an option 63 for booting the OS from the optical disk, an option 64 for booting the OS from the USB device, an option 65 for booting the OS via the network, and an option 66 for shutting down the PC 100 or booting the OS stored in the storage 17. In the case where the option 62 is selected, a menu for selecting details of the recovery processing is displayed.

Subsequently, the BIOS executes on the menu screen various types of processing according to user's selection and input.

Specifically, in the case where the booting from the USB memory is selected, the BIOS boots the OS stored in the USB memory or the medium drive connected to the USB port 18 (Steps 36 and 37). Otherwise, in the case where the booting from the optical disk is selected, the BIOS boots the OS stored in the optical disk mounted in the optical drive 20 (Steps 38 and 39).

Further, the booting from the network is selected, the BIOS downloads the OS from the predetermined device on the network, which is connected to the wired network port 19 or the wireless network chip 21, and boots the downloaded OS (Steps 40 and 41).

Further, in the case where the recovery processing is selected, the BIOS executes, according to a further instruction from the user, the recovery processing including initialization of the storage 17, creation of the recovery disk, and the like (Steps 42 and 43).

Further, in the case where a BIOS setting screen is selected, the BIOS displays the BIOS setting screen (Steps 44 and 45).

Further, in the case where the booting from the PC is selected, the BIOS boots the OS stored in the storage 17 (Steps 46 and 47).

(Operation when Power Button is Pressed)

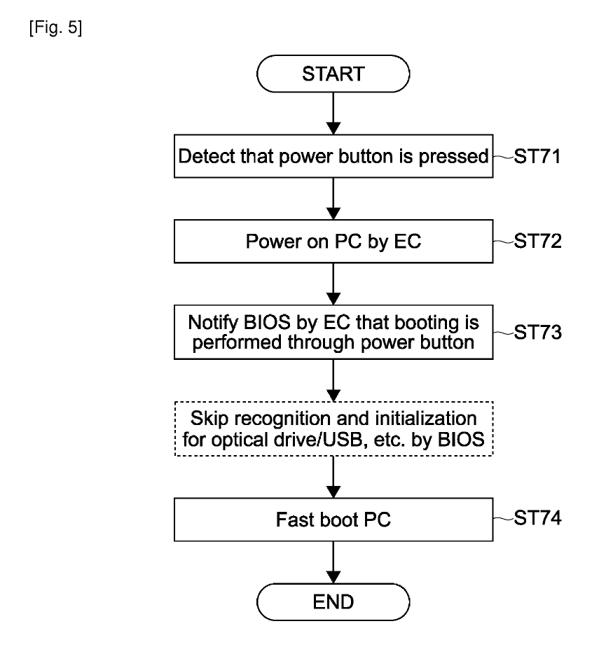

FIG. 5 is a flow chart showing a flow of operations of the PC 100 when the power button 29 is pressed.

As shown in the figure, first, the EC 16 detects that the power button 29 is pressed in a state in which the PC 100 is powered off (Step 71) and then, powers on the PC 100 (Step 72).

Subsequently, the EC 16 notifies the BIOS that a boot operation of the PC 100 is performed through the power button 29 (Step 73).

Then, the BIOS skips the recognition of the removable medium and the initialization of the drive and fast boots the OS stored in the storage 17 (Step 74).

(Operation when Assist Button is Pressed after OS Booting)

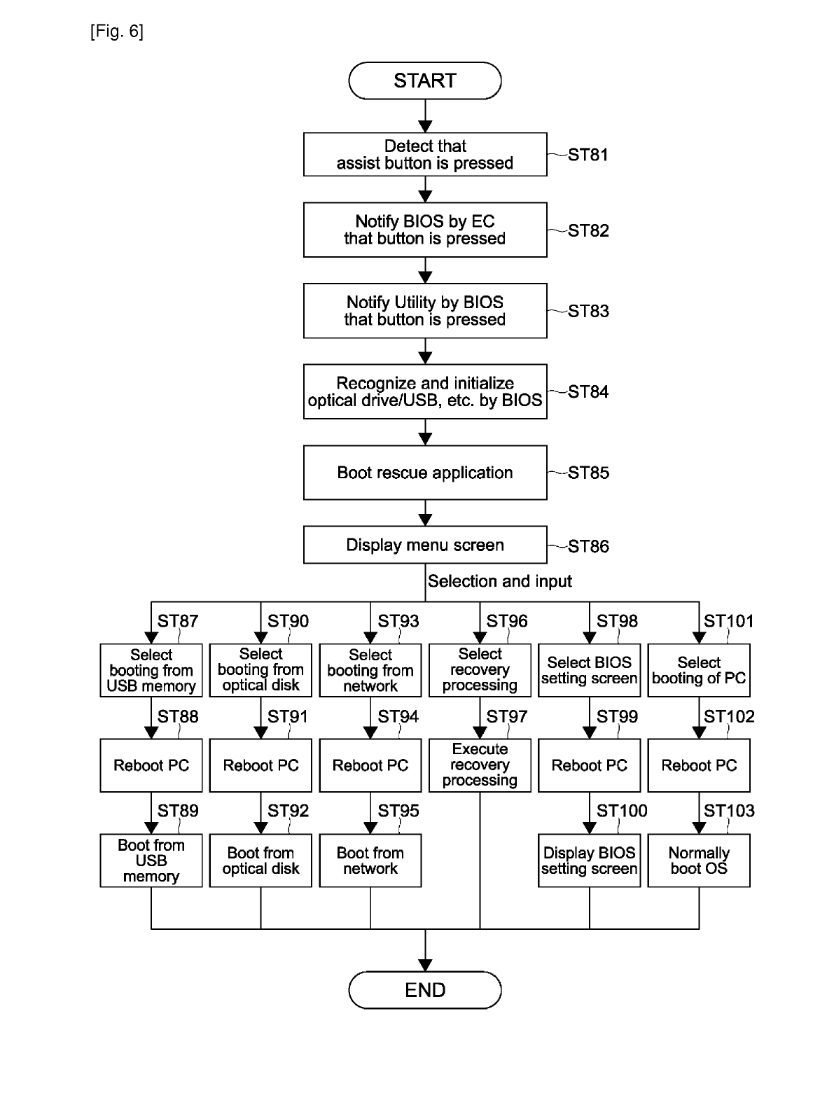

Next, operations of the PC 100 when the assist button 28 is pressed after booting the OS will be described. FIG. 6 is a flow chart showing a flow of these operations.

As shown in the figure, the EC 16 detects that the assist button 28 is pressed (Step 81) and then, notifies the BIOS of this (Step 82).

Subsequently, the BIOS notifies the above-mentioned utility OS that the assist button 28 is pressed (Step 83). Further, the BIOS recognizes the removable medium and initializes the drive (Step 84).

Subsequently, the BIOS uses the utility OS to boot the rescue application and displays the menu screen shown in FIG. 3 or FIG. 4 (Step 86).

Then, as described above with reference to in Steps 36 to 47 of FIG. 2, the BIOS executes on the menu screen various types of processing according to user's selection and input (Steps 87 to Step 103). Here, in the various types of processing, for each of booting OSs from the removable media and the network, displaying the BIOS setting screen, and normally booting the PC 100, rebooting the PC 100 (termination processing for the currently running OS) becomes necessary (Steps 88, 91, 94, 99, and 102).

As described above, the assist button 28 enables the user to easily switch OSs to be booted only by selection via the menu screen.

Optionally, a remote device, such as a smart phone or a tablet computer, may be used to display a graphical user interface (GUI) for controlling the information processing device at a remote distance, such as within WI-FI range. For example, the information processing device may be a PC, that connects (wirelessly or directly) to a television (TV) monitor. The TV monitor may be used as the display for the PC, and the remote device may be used as the triggering device for performing a boot sequence for the PC, as well as another triggering device for performing the fast boot process. The GUI is a downloadable APP that, once executed on the remote device, includes two icons (for the two triggering devices), which provide the user a choice of performing a full boot or a fast boot, for example.

(Conclusion)

As mentioned above, according to this embodiment, the PC 100 provides two booting routes due to the assist button 28 and the power button 29. Specifically, when the assist button 28 is pressed, the PC 100 recognizes the removable medium and initializes the drive after power-on, and displays the menu screen for selection of processing including booting the OS from the removable medium, setting the BIOS, recovery, and the like. Further, when the power button 29 is pressed, the PC 100 skips the recognition of the removable medium and the initialization of the drive and fast boots the OS in the storage 17 after power-on. Due to this skipping, the OS is booted in about two-thirds of the time taken in the case where the skipping is not performed. Further, the PC 100 displays the menu screen when the assist button 28 is pressed, and hence it is possible to provide the user with a way to boot the OS from the removable medium and the like in a very simple manner comparing with an operation in a traditional PC in which a function key is pressed within one or two seconds after power-on.

### Modified Example

The present disclosure is not limited only to the above-mentioned embodiment and can be variously modified without departing from the gist of the present disclosure.

Although in the above-mentioned embodiment, as the triggers for two types of booting, the press operation on the two buttons of the assist button 28 and the power button 29 is shown, the triggers are not limited thereto. For example, two types of booting may be executed by different operations (normal press and long press) on a single button.

The options displayed on the menu screen, which are shown in the above-mentioned embodiment, are not limited to the above-mentioned options.

Although in the above-mentioned embodiment, the example in which the present disclosure is applied to the PC, the present disclosure is similarly applicable to any other information processing apparatuses including a television apparatus, a game apparatus, a car navigation apparatus, a recording and reproducing apparatus, and the like.

(Other)

The present disclosure can be also configured as follows.

(1) An information processing apparatus, including:

an operation unit capable of receiving a first operation and a second operation made by a user;

a first storage capable of storing a first operating system;

a connection unit connectable to a removable medium; and

a controller capable of powering on the information processing apparatus and recognizing the removable medium when the first operation is received and powering on the information processing apparatus and booting the first operating system, skipping the recognition of the removable medium, when the second operation is received.

(2) The information processing apparatus according to item (1), in which the operation unit includes

a first button capable of receiving the first operation, and

a second button capable of receiving the second operation.

(3) The information processing apparatus according to item (2), in which

the connection unit is connectable to a plurality of removable media each capable of storing a second operating system different from the first operating system, and

the controller is capable of outputting, when the second button is pressed, a menu screen including options for allowing the user to select out of the plurality of removable media a removable medium to be a source for booting the second operating system, and booting the second operating system according to the selection.

(4) The information processing apparatus according to item (3), in which the controller is capable of booting, when the second button is pressed after the first operating system is booted due to the first button being pressed, the second operating system by recognizing the removable medium, displaying the menu screen, and ter-minating the first operating system according to the selection.

(5) The information processing apparatus according to item (3) or (4), further including:

a communication unit capable of receiving the second operating system via a network; and

a second storage capable of storing a basic input/output system (BIOS), in which the menu screen further includes at least one of an option for booting the second operating system via the network, an option for recovering the information processing apparatus, and an option for setting the BIOS.

The present application contains subject matter related to that disclosed in Japanese Priority Patent Application JP 2011-084207 filed in the Japan Patent Office on Apr. 6, 2011, the entire content of which is hereby incorporated by reference.

### REFERENCE SIGNS LIST

11 CPU
15 flash memory
16 EC
17 storage
18 USB port
19 wired network port
20 optical drive
21 wireless network chip
25 display
28 assist button
29 power button
100 PC

1. An information processing device comprising:
a processing circuit that
performs a first power-on sequence from a first medium when a first triggering device is detected as being actuated, and
performs a second power-on sequence when a second triggering device is detected as being actuated, wherein
the first power-on sequence includes recognition of a removable medium and the second power-on sequence excludes recognition of a second medium.

2. The information processing device of claim 1, wherein
the second medium is a removable medium that includes one of an optical medium and a universal serial bus memory.

3. The information processing device of claim 1, wherein
said first power-on sequence is a boot sequence, and said second power-on sequence being completed in a shorter amount of time than the first power-on sequence.

4. The information processing device of claim 3, wherein
the boot sequence recognizes and initializes the removable medium, and generates a menu screen that is displayed on a display.

5. The information processing device of claim 1, further comprising:
the first triggering device and the second triggering device, the first triggering device being a different device than said second triggering device.

6. The information processing device of claim 5, wherein
the first triggering device and the second triggering device are user-actuatable.

7. The information processing device of claim 1, wherein
at least one of the first triggering device and the second triggering device is triggered in response to a received signal transmitted from a remote device.

8. The information processing device of claim 1, wherein
in response to the second triggering device being actuated after said first power-on sequence has started, said processing circuit provides display of a user-selectable control option of booting from a power-on sequence stored on the removable medium.

9. The information processing device of claim 8, wherein
in response to the second triggering device being actuated after said first power-on sequence has started, said processing circuit provides a plurality of user-selectable control options of booting from different power-on sequences stored on different removable media.

10. The information processing device of claim 1, wherein
the second power-on sequence is performed using computer readable instructions stored in a medium accessed via a network.

11. The information processing device of claim 1, wherein
said second power-on sequence includes recovery processing that provides a reboot capability after a system crash.

12. The information processing device of claim 1, wherein
said second power-on sequence includes display of a BIOS setting screen.

13. The information processing device of claim 1, wherein
said second power-on sequence includes executing a boot sequence of an operating system stored in a local storage device.

14. The information processing device of claim 1, wherein
said received signal is a wireless signal.

15. An information processing method comprising:
performing a first power-on sequence with a processing circuit from a first medium when a first triggering device is detected as being actuated; and
performing a second power-on sequence when a second triggering device is detected as being actuated, wherein
the first power-on sequence includes recognizing a removable medium and the second power-on sequence excludes recognizing of a second medium.

16. The method of claim 15, further comprising:
receiving a signal transmitted from a remote device, wherein
at least one of the first triggering device and the second triggering device is triggered in response to receiving the signal.

17. The method of claim 15, further comprising:
recognizing an actuation of the second triggering device after said first power-on sequence has started, and displaying of a user-selectable control option of booting from a power-on sequence stored on the removable medium.

18. The method of claim 17, further comprising:
recognizing the second triggering device as being actuated after said first power-on sequence has started, and in response displaying a plurality of user-selectable control options of booting from different power-on sequences stored on different removable media.

19. A non-transitory computer readable storage medium having computer readable instructions stored therein that when executed by a processing circuit perform a method comprising:
performing a first power-on sequence with the processing circuit from a first medium when a first triggering device is detected as being actuated; and
performing a second power-on sequence when a second triggering device is detected as being actuated, wherein
the first power-on sequence includes recognizing a removable medium and the second power-on sequence excludes recognizing of a second medium.

20. The storage medium of claim 19, wherein the method further comprising:
receiving a signal transmitted from a remote device, wherein at least one of the first triggering device and the second triggering device is triggered in response to receiving the signal.
